(19) United States
(12) Patent Application Publication
(10) Pub. No.: US 2007/0165735 A1
(43) Pub. Date: Jul. 19, 2007

(54) Method and apparatus for supporting transmit diversity in a receiver

(75) Inventors: Jung-Lin Pan, Selden, NY (US); Rui Yang, Greenlawn, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/376,944

(22) Filed: Mar. 16, 2006

Related U.S. Application Data
(60) Provisional application No. 60/760,022, filed on Jan. 18, 2006.

(51) Int. Cl. H04L 1/02

(52) U.S. Cl. 375/267; 375/347

(57) ABSTRACT

A method and apparatus for supporting transmit diversity are disclosed. A wireless communication system includes a transmitter having a plurality of transmit antennas and a receiver having at least one receive antenna. The transmitter transmits different pilot code sequences via each of the transmit antennas. The receiver comprises at least one receive antenna for receiving signals transmitted from the transmitter and a plurality of equalizers. Each equalizer is locked onto one of the transmit antennas and processes received samples using a corresponding pilot code sequence. The equalizer may treat user data and pilot code sequence transmitted via all other transmit antennas except the corresponding transmit antenna as interference or alternatively may cancel pilot or pilot and data in parallel or successively.

### CROSS REFERENCE TO RELATED APPLICATION

This application claims the benefit of U.S. provisional application No. 60/760,022 filed Jan. 18, 2006, which is incorporated by reference as if fully set forth.

### FIELD OF INVENTION

The present invention is related to wireless communication systems. More particularly, the present invention is related to a method and apparatus for supporting transmit diversity in a wireless communication system.

### BACKGROUND

An adaptive equalizer based receiver, such as a normalized least mean square (NLMS)-based receiver, provides superior performance for high data rate services such as frequency division duplex (FDD) high speed downlink packet access (HSDPA) or code division multiple access (CDMA) 2000 evolution data and voice (EV-DV) over a Rake receiver.

An NLMS algorithm is used for equalizer filter tap coefficient adaptation to generate and update appropriate filter tap coefficients used by the equalizer filter. Typically, error signal computation, vector norm calculation and leaky integration are performed to generate and update the filter tap coefficients.

A channel estimation (CE)-NLMS receiver is another example of an advanced receiver that may provide high data rate services. In the CE-NLMS receiver, a channel estimate is used for updating the filter tap coefficients.

Conventional systems either do not use transmit diversity for adaptive equalization, or use transmit diversity but perform data equalization in a straight forward method for equalization without any joint design and interference cancellation. In a straight forward method for transmit diversity based adaptive filtering, two equalizers using an equalization filter, such as an NLMS equalization filter, are used independently and separately for two transmit antennas. Each equalization filter equalizes the signal distortion of its assigned transmit antenna without considering the interference from the other transmit antenna. However, such a system does not offer optimum performance.

### SUMMARY

The present invention is related to a method and apparatus for supporting transmit diversity. A wireless communication system includes a transmitter having a plurality of transmit antennas and a receiver having at least one receive antenna. The transmitter transmits different pilot code sequences via each of the transmit antennas. The receiver comprises at least one receive antenna for receiving signals transmitted from the transmitter and a plurality of equalizers. Each equalizer is locked onto one of the transmit antennas and processes received samples using a corresponding pilot code sequence. The equalizer may treat user data and pilot code sequence transmitted via all other transmit antennas except the corresponding transmit antenna as interference or alternatively may cancel pilot or pilot and data in parallel or successively.

### BRIEF DESCRIPTION OF THE DRAWINGS

FIG. 1 is a block diagram of a receiver supporting transmit diversity in accordance with one embodiment of the present invention.

FIG. 2 is a block diagram of a receiver supporting transmit diversity in accordance with another embodiment of the present invention.

FIG. 3 is a block diagram of a receiver supporting transmit diversity while implementing parallel interference cancellation (PIC) in accordance with the present invention.

FIG. 4 is a block diagram of a receiver implementing PIC or successive interference cancellation (SIC) selectively in accordance with the present invention.

FIG. 5 is a block diagram of a receiver using a joint chip-level equalizer for open loop transmit diversity in accordance with the present invention.

FIG. 6 is a block diagram of a receiver using a chip-level equalizer for closed loop transmit diversity in accordance with the present invention.

FIG. 7 is a block diagram of an HSDPA receiver using a chip-level equalizer for open and closed loop transmit diversity in accordance with the present invention.

FIG. 8 is a block diagram of a receiver including a combined chip-level equalizer for open and closed loop transmit diversity in accordance with the present invention.

### DETAILED DESCRIPTION OF THE PREFERRED EMBODIMENTS

The features of the present invention may be incorporated into an integrated circuit (IC) or be configured in a circuit comprising a multitude of interconnecting components.

The present invention provides a method and apparatus for transmit diversity processing for a receiver. The present invention is applicable to any wireless communication system including, but not limited to, universal mobile telecommunication system (UMTS) frequency division duplex (FDD) high-speed downlink packet access (HSDPA). The present invention may be implemented using either CE-NLMS or NLMS for either open-loop or close-loop transmit diversity. The transmit diversity may be implemented using any number of transmit antennas, and the receiver may include a single receive antenna or multiple receive antennas for receive diversity and joint processing.

In accordance with a first embodiment of the present invention, a receiver algorithm for transmit diversity is provided. In accordance with a second embodiment of the present invention, an advanced joint algorithm using interference cancellation is provided. The present invention will be explained with reference to a transmitter having two transmit antennas and a receiver having one or two receive antennas as an example. However, it should be noted that the present invention may be applied to any number of transmit and receive antennas.

For open-loop transmit diversity, the received signal can be expressed as follows:

$$\vec{r} = \frac{1}{\sqrt{2}} {H}_{1} \vec{x} + \frac{1}{\sqrt{2}} {H}_{2} {\vec{x}}_{2} + \vec{n} ; \qquad Equation ( 1 )$$

where H₁ and H₂ are the channel response matrix for transmit antenna 1 and transmit antenna 2, respectively. \vec{x}₁ and \vec{x}₂ are the transmitted data plus pilot signal of transmit antenna 1 and transmit antenna 2, respectively. \vec{n} is a noise vector.

The \vec{x}₁ and \vec{x}₂ can be expressed by data and pilot signal as follows:

$$\begin{matrix}{\vec{x}}_{1} = {p}_{1} + {\sum }_{k = 1}^{K} {\vec{y}}_{1}^{( k )} ; \\ and & Equation ( 2 ) \\ {\vec{x}}_{2} = {p}_{2} + {\sum }_{k = 1}^{K} {\vec{y}}_{2}^{( k )} ; & Equation ( 3 )\end{matrix}$$

where p₁ and P₂ are pilot signals, (or common pilot channel (CPICH) signals), for transmit antenna 1 and transmit antenna 2, respectively. Let p₁ and P₂ represent CPICH 1 and CPICH 2, respectively. \vec{y}₁^{(k)} and \vec{y}₂^{(k)} are spread data for user k, (or code k), that are transmitted via transmit antenna 1 and transmit antenna 2, respectively. Substituting Equations (2) and (3) into Equation (1), Equation (1) can be expressed as follows:

$$\vec{r} = \frac{1}{\sqrt{2}} {H}_{1} ( {p}_{1} + {\sum }_{k = 1}^{K} {\vec{y}}_{1}^{( k )} ) + \frac{1}{\sqrt{2}} {H}_{2} ( {p}_{2} + {\sum }_{k = 1}^{K} {\vec{y}}_{2}^{( k )} ) + \vec{n} . \qquad Equation ( 4 )$$

For open-loop space time transmit diversity (STTD), \vec{y}₁^{(k)} and \vec{y}₂^{(k)} are the spread data of data symbols \vec{d}^{(k)} that are STTD encoded in both space and time domain. For quadrature phase shift keying (QPSK), the STTD encoded data sequences for transmit antenna 1 and transmit antenna 2 are as follows:
\vec{d}₁=[b₀ b₁ b₂ b₃]^{T},
and
\vec{d}₂=[ b̅₂̅ b₃ b₀ b̅₁̅]^{T}.

For 16 quadrature amplitude modulation (QAM), the STTD encoded data sequences for transmit antenna 1 and transmit antenna 2 are as follows:
\vec{d}₁=[b₀ b₁ b₂ b₃ b₄ b₅ b₆ b₇]^{T},
and
\vec{d}₂=[ b̅₄̅ b₅ b₆ b₇ b₀ b̅₁̅ b₂ b₃]^{T}.

For closed-loop transmit diversity, the received signal can be expressed as follows:

$$\vec{r} = {H}_{1} ( \frac{1}{\sqrt{2}} {p}_{1} + {\vec{s}}_{1} ) + {H}_{2} ( \frac{1}{\sqrt{2}} {p}_{2} + {\vec{s}}_{2} ) + \vec{n} ; \qquad Equation ( 5 )$$

where

$$\begin{matrix}{\vec{s}}_{1} = {\sum }_{k = 1}^{K} {w}_{1}^{( k )} {\vec{y}}^{( k )} ; \\ and & Equation ( 6 ) \\ {\vec{s}}_{2} = {\sum }_{k = 1}^{K} {w}_{2}^{( k )} {\vec{y}}^{( k )} . & Equation ( 7 )\end{matrix}$$

For closed-loop transmit diversity, the same data \vec{y}^{(k)} are transmitted via the transmit antennas with user-specific weights applied. w₁^{(k)} and w₂^{(k)} are the weights applied for user k, (or code k), for transmit antennas 1 and 2, respectively.

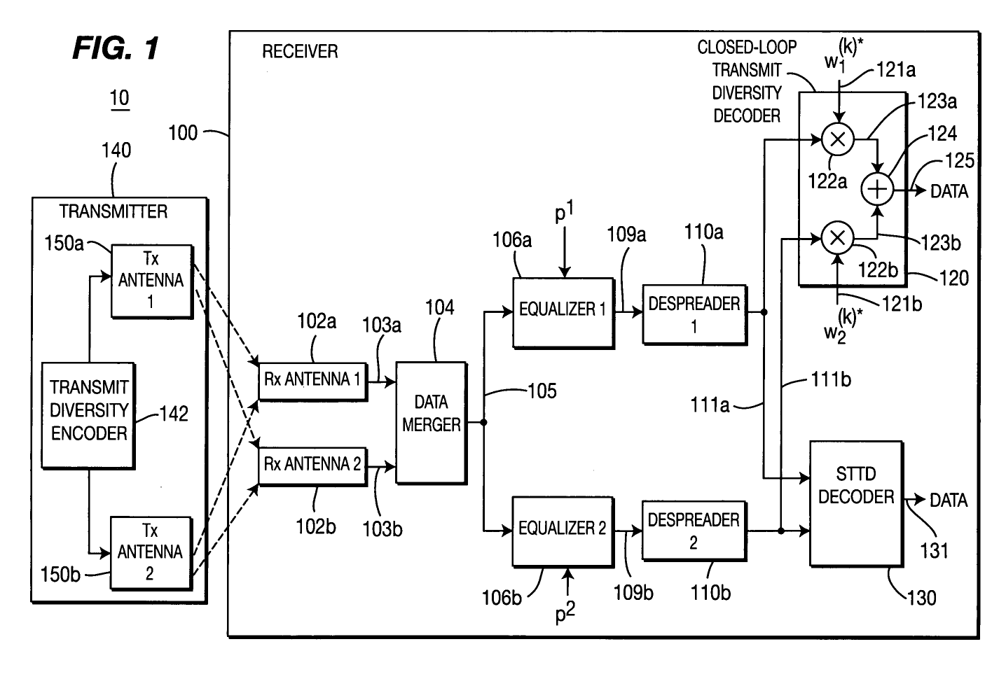

FIG. 1 is a block diagram of a wireless communication system 10 including a transmitter 140 and a receiver 100 for supporting transmit diversity in accordance with one embodiment of the present invention. The transmitter 140 includes a transmit diversity encoder 142 and at least two transmit antennas 150a, 150b. The receiver 100 comprises receive antennas 102a, 102b, a data merger 104, (if two or more receive antennas are used), a plurality of equalizers 106a, 106b, a plurality of despreaders 110a, 110b and a closed-loop transmit diversity decoder 120 and/or an STTD decoder 130. It should be noted that while FIG. 1 depicts two transmit antennas 150a, 150b and two receive antennas 102a, 102b as an example, more than two transmit antennas and any number of receive antennas may be utilized. If multiple receive antennas are used as shown in FIG. 1, the data merger 104 is used to combine the received data 103a, 103b via the receive antennas into one data stream 105. If only one receive antenna is used, the data merger 104 is not necessary. The transmit diversity encoder 142 may implement open-loop transmit diversity, (i.e., STTD), or closed-loop transmit diversity. The receiver 100 may include only one of the closed-loop transmit diversity decoder 120 and the STTD decoder 130, or may include both of them and selectively implement the transmit diversity processing.

The receive antennas 102a, 102b receive signals transmitted via at least two transmit antennas 150a, 150b. The received signals 103a, 103b via each of the receive antennas 102a, 102b are merged into one stream of received data 105 by the data merger 104. The merged received data 105 is fed into the equalizers 106a, 106b. In the first embodiment, the equalizers 106a, 106b are NLMS equalizers. Alternatively, any type of adaptive equalizers may be used. Each equalizer 106a, 106b is locked onto one of the transmit antennas 150a, 150b of the transmitter 101. Each equalizer 106a, 106b performs equalization as if there is only one transmit antenna, (e.g., transmit antenna 150a), present and considers transmission by the other transmit antenna, (e.g., transmit antenna 150b), as interference.

For STTD open-loop transmit diversity, a first equalizer 106a uses pilot signal p₁, (e.g., CPICH 1), transmitted via the first transmit antenna 150a, and a second equalizer 106b uses pilot signal p₂, (e.g., CPICH 2), transmitted via the second transmit antenna 150b as a reference signal, respectively. The first equalizer 106a uses pilot signal p₁ for equalizing H₁ to obtain

$${\vec{y}}_{1} ( {\vec{y}}_{1} = {\sum }_{k = 1}^{K} {\vec{y}}_{1}^{( k )} )$$

and treats signals from the second transmit antenna 150b as interference such that:

$$\vec{r} = \frac{1}{\sqrt{2}} {H}_{1} ( {p}_{1} + {\sum }_{k = 1}^{K} {\vec{y}}_{1}^{( k )} ) + {I}_{2} + \vec{n} ; \qquad Equation ( 8 )$$

where I₂ is the interference arising from the second transmit antenna 150b including data and pilot transmitted via the second transmit antenna 150b.

Similarly to obtain

$${\vec{y}}_{2} ( {\vec{y}}_{2} = {\sum }_{k = 1}^{K} {\vec{y}}_{2}^{( k )} ) ,$$

the second equalizer 106b equalizes H₂ using pilot signal p₂ and treats signals from the first transmit antenna 150a as interference such that:

$$\vec{r} = \frac{1}{\sqrt{2}} {H}_{2} ( {p}_{2} + {\sum }_{k = 1}^{K} {\vec{y}}_{2}^{( k )} ) + {I}_{1} + \vec{n} ; \qquad Equation ( 9 )$$

where I₁ is the interference arising from the first transmit antenna 150a including data and pilot signal transmitted via the first transmit antenna 150a.

The equalized data outputs 109a, 109b from the equalizers 106a, 106b are fed into the despreaders 110a, 110b, respectively. The despreaders 110a, 110b despread the equalized data 109a, 109b, (i.e., the estimates of \vec{y}₁ and \vec{y}₂), to obtain the estimates of the transmitted data symbols, \vec{d}^{(k)}, 111a, 111b for user k, (or code k) as follows:

$${\hat{\vec{d}}}_{i}^{( k )} = {C}^{{( k )}^{H}} \hat{\vec{{y}_{i}}} , i = 1 , 2 ;$$

where C^{(k)} is the channelization code matrix of user k, (or code k). The estimates of the transmitted data symbols 111a, 111b are then fed into either the closed-loop diversity decoder 120 or the STTD decoder 130.

The closed-loop diversity decoder 120 includes a plurality of multipliers 122a, 122b and a summer 124. Conjugate 121a, 121b of the corresponding weights, that are multiplied at the transmit diversity encoder 142 of the transmitter 140, are multiplied to the data symbols 111a, 111b by the multipliers 122a, 122b, and the multiplication results 123a, 123b are combined by the summer 124 to generate data 125 such that:

$${{d}^{\hat{\_}}}^{( k )} = {C}^{{( k )}^{H}} ( {w}_{1}^{{( k )}^{*}} \cdot {{s}^{\hat{\_}}}_{1} + {w}_{2}^{{( k )}^{*}} \cdot {{s}^{\hat{\_}}}_{2} ) . \qquad Equation ( 11 )$$

The STTC decoder 130 processes the estimates of the transmitted data symbols 111a, 111b to obtain the data bₙ 131 for user k, (or code k).

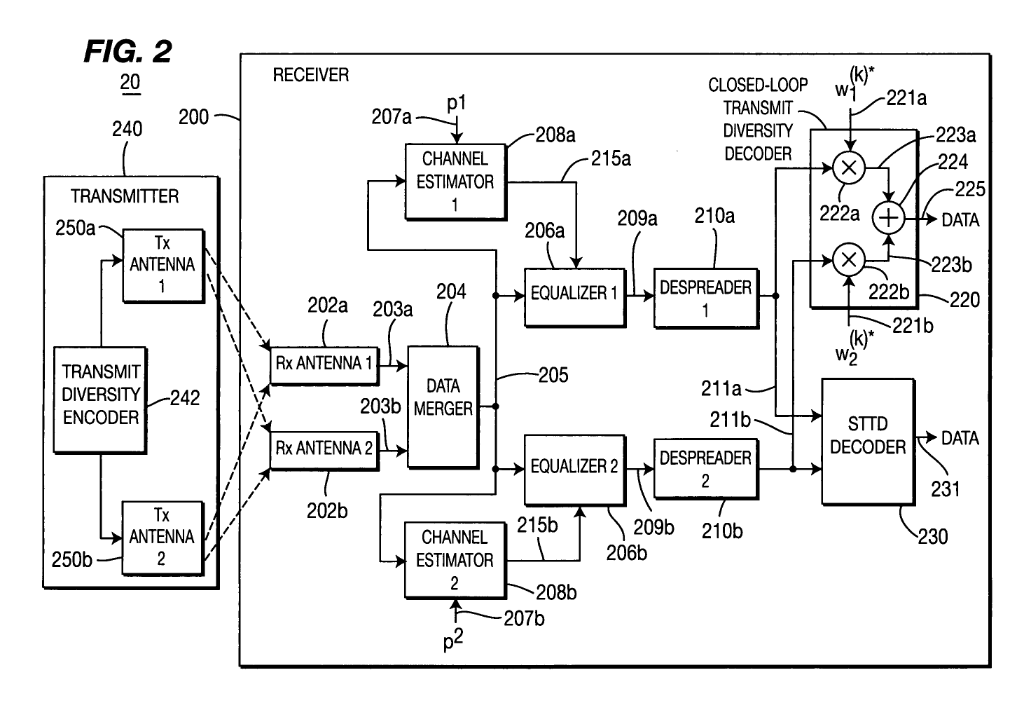

FIG. 2 is a block diagram of a system 20 including a transmitter 240 and a receiver 200 for supporting transmit diversity processing in accordance with another embodiment of the present invention. The transmitter includes a transmit diversity encoder 242 and at least two transmit antennas 250a, 250b. The receiver 200 includes receive antennas 202a, 202b, a data merger 204, (if two or more receive antennas are used), a plurality of equalizers 206a, 206b, a plurality of channel estimators 208a, 208b, a plurality of despreaders 210a, 210b and a closed-loop transmit diversity decoder 220 and/or an STTD decoder 230. The structure of the receiver 200 is similar to that of the receiver 100 except that the equalizers 206a, 206b are CE-NLMS equalizers instead of NLMS equalizers. As indicated hereinbefore, more than two transmit antennas and any number of receive antennas may be utilized. If multiple receive antennas are used as shown in FIG. 2, the data merger 204 is used to combine the received data 203a, 203b via the receive antennas into one data stream 205. If only one receive antenna is used, the data merger 204 is not necessary. The transmit diversity encoder 242 may implement open-loop transmit diversity, (i.e., STTD), or closed-loop transmit diversity. The receiver 200 may include only one of the closed-loop transmit diversity decoder 220 and the STTD decoder 230, or may include both of them and selectively implement the transmit diversity processing.

The receive antennas 202a, 202b receive transmitted signals transmitted via the transmit antennas 250a, 250b. The received signals 203a, 203b from each of the receive antennas 202a, 202b are merged into one stream of received data 205 by the data merger 204. The merged received data 205 is fed into the equalizers 206a, 206b and the channel estimators 208a, 208b. In this embodiment, the equalizers 206a, 206b are CE-NLMS equalizers. The CE-NLMS equalizers 206a, 206b use a channel estimate 215a, 215b generated by the channel estimators 208a, 208b, respectively, for filter tap coefficients adaptation such that:
\vec{w}ₖ=α\vec{w}ₖ₋₁+β(E{p·\vec{z}ₖ^{H}}−\vec{u}ₖ·\vec{z}ₖ^{H}); Equation (12)
where

$$β = \frac{μ}{{‖ {\overline{z}}_{k} ‖}^{2}} ,$$

uₖ denotes the descrambled equalizer output such that
uₖ=\vec{z}ₖ\vec{w}ₖ; Equation (13)
where \vec{w}ₖ are the filter coefficients of iteration k. The expectation E{p·\vec{z}ₖ^{H}} can be obtained from channel estimation or channel state information (CSI).

Each equalizer 206a, 206b is locked onto one of the transmit antennas 250a, 250b of the transmitter and performs equalization as if there is only one transmit antenna (e.g., transmit antenna 250a) present and considers transmission by the other transmit antenna (e.g., transmit antenna 250b) as interference. The equalized data outputs 209a, 209b from the equalizers 206a, 206b are fed into the despreaders 210a, 210b, respectively. The despreaders 210a, 210b despread the equalized data 209a, 209b, (i.e., the estimates of \vec{y}₁ and \vec{y}₂), to obtain the estimates of the transmitted data symbols, \vec{d} (k), 211a, 211b for user k, (or code k). The estimates of the transmitted data symbols 211a, 211b are then fed into either the closed-loop diversity decoder 220 or the STTD decoder 230 to recover the data as explained hereinbefore. The closed-loop diversity decoder 220 includes a plurality of multipliers 222a, 222b and a summer 224. Conjugate 221a, 221b of the corresponding weights, that are multiplied at the transmit diversity encoder 242, are multiplied to the data symbols 211a, 211b at the multipliers 222a, 222b, and the multiplication results 223a, 223b are combined by the summer 224 to generate data 225. The STTC decoder 230 processes the estimates of the transmitted data symbols 211a, 211b to obtain the data bₙ 231 for user k, (or code k).

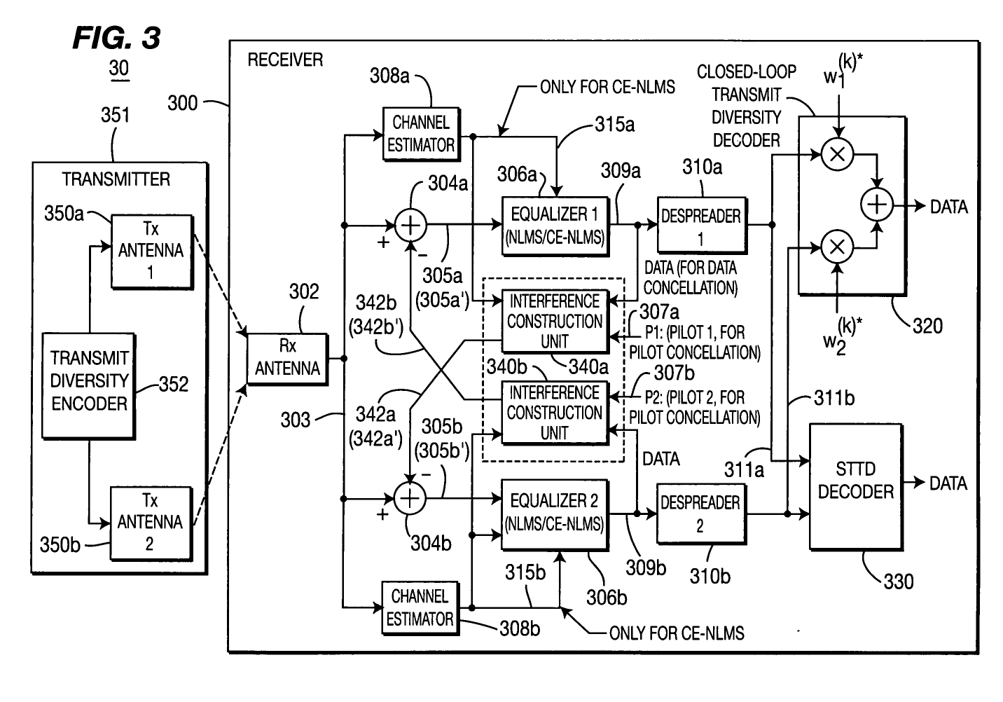

FIG. 3 is a block diagram of a system 30 including a transmitter 351 and a receiver 300 supporting transmit diversity while implementing PIC in accordance with the present invention. The receiver 300 implements interference cancellation based equalization. The transmitter 351 includes a transmit diversity encoder 352 and a plurality of transmit antennas 350a, 350b. The receiver 300 includes a receive antenna 302, a plurality of equalizers 306a, 306b, a plurality of channel estimators 308a, 308b, a plurality of adders 304a, 304b, a plurality of interference construction units 340a, 340b, a plurality of despreaders 310a, 310b and a closed-loop transmit diversity decoder 320 and/or an STTD decoder 330. It should be noted that FIG. 3 depicts two transmit antennas and one receive antenna as an example, and more than two transmit antennas and/or receive antennas may be utilized. If multiple receive antennas are used, the received signals via each of the receive antennas may be merged into one stream of received data by a data merger (not shown) as shown in FIGS. 1 and 2.

The receive antenna 302 receives signals transmitted via at least two transmit antennas 350a, 350b. The received data 303 is fed into the channel estimators 308a, 308b and the equalizers 306a, 306b via the adders 304a, 304b. Each channel estimator 308a, 308b and each equalizer 306a, 306b are locked onto one of the transmit antennas 350a, 350b. The channel estimators 308a, 308b generate channel estimates 315a, 315b using corresponding pilot signals p₁ and p₂. The equalizers 306a, 306b may be NLMS equalizers, CE-NLMS equalizers or any type of adaptive equalizers. If CE-NLMS equalizers are used, the channel estimates 315a, 315b are fed into the equalizers 306a, 306b to be used in equalization.

There are two options for interference cancellation: pilot cancellation only and pilot plus data cancellation. For pilot cancellation only, the interference construction units 340a, 340b receive pilot signals 307a, 307b and channel estimates 315a, 315b generated by the channel estimators 308a, 308b, respectively, and construct a pilot with channel responses, (Ĥ₁p₁ and Ĥ₂p₂) 342a, 342b, respectively. The pilot with channel responses 342a, 342b are then subtracted by the adders 304a, 304b from the received data 303. The subtraction of the constructed pilot with channel response 342a, 342b is expressed as follows:

$$\begin{matrix}{\vec{r}}_{1} = \vec{r} - \frac{1}{\sqrt{2}} {\hat{H}}_{2} {p}_{2} ; & Equation ( 14 ) \\ {\vec{r}}_{2} = \vec{r} - \frac{1}{\sqrt{2}} {\hat{H}}_{1} {p}_{1} . & Equation ( 15 )\end{matrix}$$

The resulting pilot-cancelled received signal, (\vec{r}₁ and \vec{r}₂), 305a, 305b are then fed into the equalizers 306a, 306b. The pilot cancellation does not require feedback from output of equalizers for interference cancellation. The equalized data 309a, 309b are then fed to the despreaders 310a, 310b for despreading. Despread data 311a, 311b are then fed to the closed loop transmit diversity decoder 320 or the STTD decoder 330 and decoded as explained hereinbefore.

For pilot and data cancellation, the equalizers 306a, 306b first equalize H₁ and H₂ separately using pilot signals p₁ and p₂, respectively. After equalization, data parts, \vec{y}₁, \vec{y}₂ or \vec{s}₁, \vec{s}₂ are estimated and fed into the interference construction units 340a, 340b, respectively. The interference construction units 340a, 340b construct pilot and data with channel responses 342a′, 342b′ for transmit antennas 350a, 350b, respectively. The pilot and data with channel responses 342a′, 342b′ are then subtracted from the received data 303 such that:
\vec{r}₁=\vec{r}−Î₂; Equation (16)
\vec{r}₂=\vec{r}−Î₁; Equation (17)
where Î₁ and Î₂ are estimated interferences arising from the transmit antennas 350a, 350b, respectively.

For open-loop STTD Î₁ and Î₂ are as follows:

$$\begin{matrix}{\hat{I}}_{1} = \frac{1}{\sqrt{2}} {\hat{H}}_{1} ( {p}_{1} + {\sum }_{k = 1}^{K} {{y}^{\hat{\to }}}_{1}^{( k )} ) ; & Equation ( 18 ) \\ {\hat{I}}_{1} = \frac{1}{\sqrt{2}} {\hat{H}}_{2} ( {p}_{2} + {\sum }_{k = 1}^{K} {{y}^{\hat{\to }}}_{2}^{( k )} ) . & Equation ( 19 )\end{matrix}$$

For close-loop transmit diversity Î₁ and Î₂ are as follows:

$$\begin{matrix}{\hat{I}}_{1} = {\hat{H}}_{1} ( \frac{1}{\sqrt{2}} {p}_{1} + {{s}^{\hat{\to }}}_{1} ) ; & Equation ( 20 ) \\ {\hat{I}}_{2} = {\hat{H}}_{2} ( \frac{1}{\sqrt{2}} {p}_{2} + {{s}^{\hat{\to }}}_{2} ) . & Equation ( 21 )\end{matrix}$$

The resulting pilot/data-cancelled received signal (\vec{r}₁ and \vec{r}₂) 305a′, 305b′ are then equalized by the equalizers 306a, 306b, respectively. The equalized data 309a, 309b are then fed to the despreaders 310a, 310b for despreading. Despread data 311a, 311b are then fed to the closed loop transmit diversity decoder 320 or the STTD decoder 330 and decoded as explained hereinbefore.

This embodiment requires channel estimation information. Either NLMS or CE-NLMS may be used as equalization, but CE-NLMS is preferred when channel estimation is available.

The interference cancellation can be performed either in soft or hard forms depending on the implementation and performance consideration. When the interference cancellation is performed in a soft form for the data, the input to the interference construction units 340a, 340b is soft samples, which can be obtained from the outputs 309a, 309b of the equalizers 306a, 306b. If the interference cancellation is performed in a hard form, the inputs to the interference construction units 340a, 340b are fed to hard decision devices (not shown) first and then the output of the hard decision device is fed to the interference construction units 340a, 340b sequentially. The hard decision devices restore the samples to the signal constellation according to the transmitted signal constellation, such as quadrature phase shift keying (QPSK) or quadrature amplitude modulation (QAM). When pilot cancellation is used, the interference construction for pilot should implement the hard form in the interference construction units 340a, 340b because the pilot sequences are known sequences to the receivers and no estimation is needed for the pilot sequences.

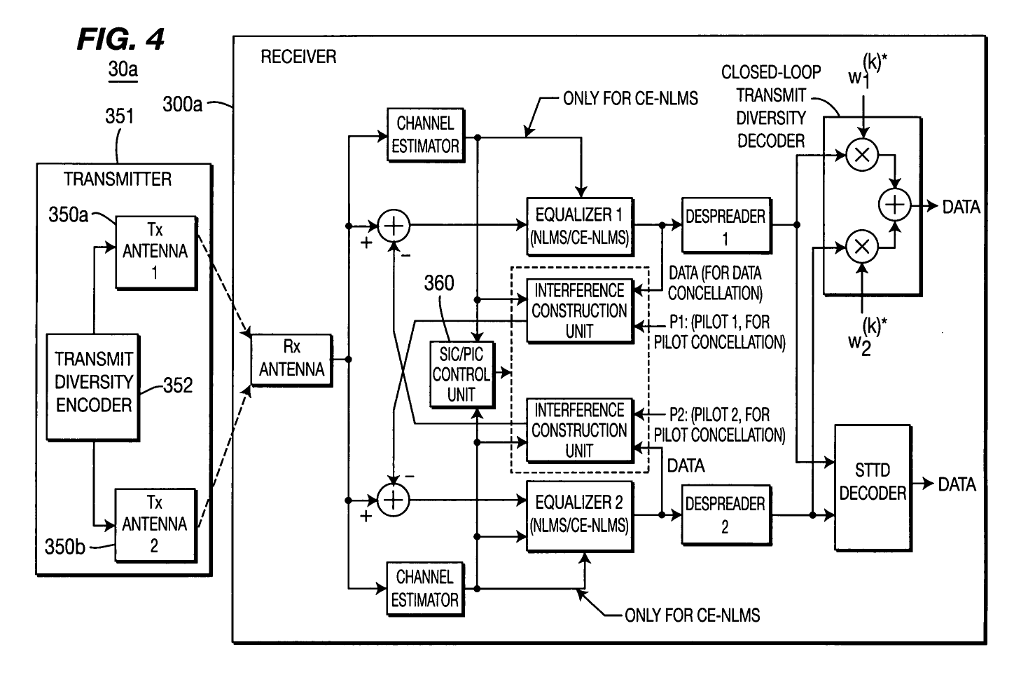

FIG. 4 is a block diagram of a system 30a including a transmitter 351 and a receiver 300a implementing PIC or SIC selectively in accordance with the present invention. The structure of the receiver 300a is similar to that of the receiver 300 except that the receiver 300a further includes an SIC/PIC controller 360 to implement PIC or SIC selectively. The receiver 300a implements a PIC between transmit antennas 350a, 350b. When the received power from two transmit antennas 350a, 350b are not equal, SIC may be advantageous.

The channel estimators 308a, 308b measure power of the corresponding pilot signals and the SIC/PIC controller 360 receives the measured power related to the two transmit antennas 350a, 350b as input and sorts the transmit antennas 350a, 350b in descending order according to the measured power. The SIC/PIC controller 360 then determines whether the power difference between two transmit antennas 350a, 350b exceeds a predetermined threshold. If the power difference exceeds the threshold, the SIC/PIC controller 360 selects SIC. Otherwise, the SIC/PIC controller 360 selects PIC. The SIC/PIC selection may be static or dynamic.

If SIC is selected, the received signal from a transmit antenna with stronger received signal power is equalized first, and the interference of the stronger power transmit antenna signals is constructed and subtracted from the received signal. The resulting signal is then equalized for the transmit antenna having a weaker received signal power.

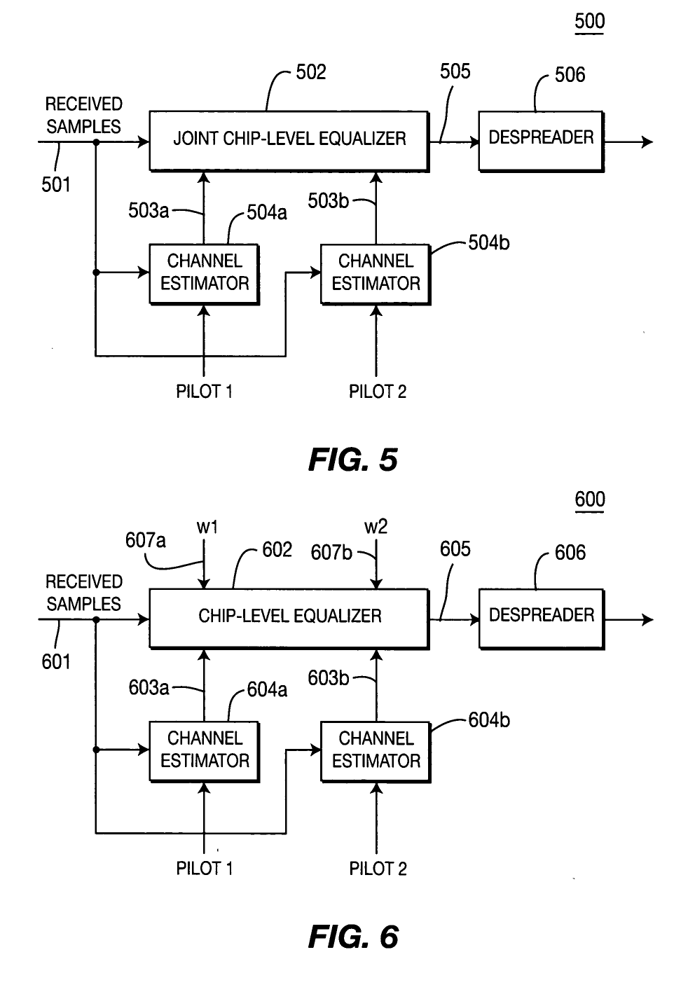

FIG. 5 is a schematic block diagram of a receiver 500 using a joint chip-level equalizer for open loop transmit diversity in accordance with the present invention. The receiver 500 includes a joint chip-level equalizer 502, a plurality of channel estimators 504a, 504b and a despreader 506. Received samples 501, which are generated from received signals from two or more transmit antennas (not shown), are fed to the joint chip-level equalizer 502 and the channel estimators 504a, 504b. Each channel estimator 504a, 504b is locked onto one of the transmit antennas and generates channel estimates 503a, 503b using corresponding pilot signals. The joint chip-level equalizer 502 utilizes the channel estimates 503a, 503b for equalizing the received samples 501. The equalized received samples 505 are then fed to the despreader 506 for despreading.

FIG. 6 is a schematic block diagram of a receiver 600 using a chip-level equalizer 602 for closed loop transmit diversity in accordance with the present invention. The structure of the receiver 600 is similar to that of the receiver 500 except the chip level equalizer 602 implements closed-loop transmit diversity. The chip-level equalizer 602 receives the weights 607a, 607b along with the channel estimates 603a, 603b generated by the channel estimators 604a, 604b and outputs equalized received samples 605 multiplied by the weights at chip rate. The equalized received samples 605 are then fed to the despreader 606 for despreading.

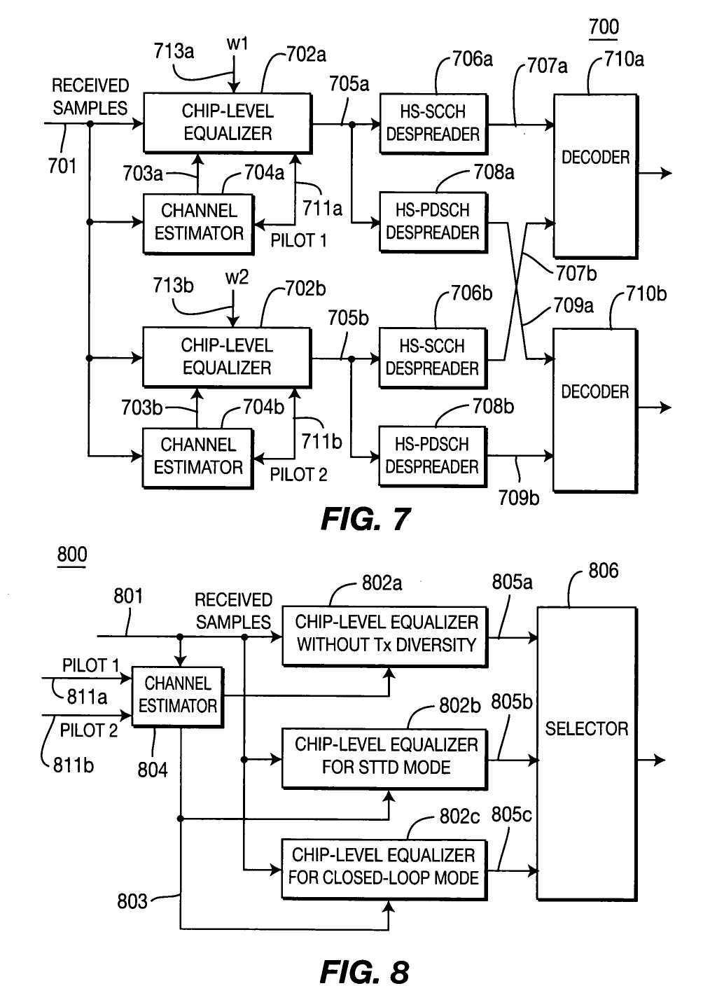

FIG. 7 is a block diagram of an HSDPA receiver 700 using a chip-level equalizer for open and closed loop transmit diversity in accordance with the present invention. The receiver 700 includes a plurality of chip level equalizers 702a, 702b, a plurality of channel estimators 704a, 704b, a plurality of high speed shared control channel (HS-SCCH) despreaders 706a, 706b, a plurality of high speed physical downlink shared channel (HS-PDSCH) despreaders 708a, 708b and a plurality of decoders 710a, 710b.

Received samples 701 are fed to the chip-level equalizers 702a, 702b and the channel estimators 704a, 704b. Each of the chip-level equalizers 702a, 702b and each of the channel estimators 704a, 704b are locked onto one of the transmit antennas (not shown). Each of the channel estimators 704a, 704b generates channel estimates 703a, 703b using an associated pilot signal 711a, 711b, respectively. Each of the chip-level equalizers 702a, 702b equalizes the received samples 701 using either the channel estimates 703a, 703b or pilot signals 711a, 711b depending on the type of equalizer. If the chip-level equalizers 702a, 702b are NLMS equalizers, the pilot signals 711a, 711b are used, and if the chip-level equalizers 702a, 702b are CE-NLMS equalizers, the channel estimates 703a, 703b are used.

The transmit diversity may be either open loop or closed loop. In closed loop transmit diversity, the chip level equalizers 702a, 702b receive weights 713a, 713b, respectively, and multiples them to the equalized samples at chip rate.

Each of the equalized received samples 705a, 705b is fed to the corresponding HS-SCCH despreaders 706a, 706b and the HS-PDSCH despreaders 708a, 708b, respectively. The HS-SCCH despreaders 706a, 706b and the HS-PDSCH despreaders 708a, 708b despread for an HS-SCCH and a high speed downlink shared channel (HS-DSCH). The HS-SCCH despread data 707a, 707b are fed to the first transmit diversity decoder 710a and the HS-DSCH despread data 709a, 709b are fed to the second transmit diversity decoder 710b. The transmit diversity decoders may be STTD decoders or closed-loop transmit diversity decoders.

FIG. 8 is a block diagram of a receiver 800 including a combined chip-level equalizer for open and closed loop transmit diversity in accordance with the present invention. The receiver 800 includes chip-level equalizers 802, channel estimators 804 and a selector 806. Multiple channel estimators 804 are provided such that each of the channel estimators is locked on to one of the transmit antennas (not shown) to generate channel estimate 803 using a corresponding pilot signals 811a, 811b. Preferably, the chip-level equalizers 802 include a chip-level equalizer without transmit diversity 802a, a chip-level equalizer for STTD mode 802b, a chip-level equalizer for closed-loop mode 802c. The chip-level equalizers 802a, 802b, 802c receive received samples 801 and channel estimates 803, and outputs equalized received samples 805, respectively. The selector 806 selects one of the outputs of the chip-level equalizers 802. When transmit diversity is not used, the selector 806 selects the output from the chip-level equalizer 802a, when STTD mode transmit diversity is used, the selector 806 selects the output from the chip-level equalizer 802b, and when closed loop mode transmit diversity is used, the selector 806 selects the output from the chip-level equalizer 802c.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system including a transmitter having a plurality of transmit antennas and a receiver having at least one receive antenna, wherein the transmitter transmits different pilot code sequences via each of the transmit antennas, a method for supporting transmit diversity in the receiver, the method comprising:
receiving signals transmitted by the transmitter;
generating a sample stream based on the received signals;
performing multiple equalizations of the sample stream to generate a plurality of equalized sample streams, each equalization being associated with one of the transmit antennas and being performed using a corresponding pilot code sequence while treating transmissions from all of the other transmit antennas as interference;
despreading the equalized sample streams to generate a plurality of despread data streams; and
performing transmit diversity decoding on the despread data streams.

2. The method of claim 1 wherein the transmit diversity is an open loop space time transmit diversity (STTD).

3. The method of claim 1 wherein the transmit diversity is a closed loop transmit diversity.

4. The method of claim 3 wherein conjugates of weights that are multiplied during transmit diversity encoding at the transmitter are multiplied to the corresponding despread data streams in performing the transmit diversity decoding.

5. The method of claim 1 wherein the equalization is normalized least mean square (NLMS) equalization.

6. The method of claim 1 wherein the equalization is channel estimation normalized least mean square (CE-NLMS) equalization.

7. The method of claim 1 wherein the receiver includes at least two receive antennas and multiple streams of samples generated from the receive antennas are merged into one combined sample stream.

8. In a wireless communication system including a transmitter having a plurality of transmit antennas and a receiver having at least one receive antenna, wherein the transmitter transmits different pilot code sequences via each of the transmit antennas, a method for supporting transmit diversity in the receiver, the method comprising:
receiving signals transmitted by the transmitter;
generating a sample stream based on the received signals;
constructing a plurality of interference signals, wherein each interference signal is associated with one of the transmit antennas and is used for canceling a pilot code sequence transmitted from all of the other transmit antennas;
subtracting each of the interference signals from the sample stream to generate a plurality of interference cancelled sample streams;
performing equalization of each of the interference cancelled sample streams to generate a plurality of equalized sample streams, each equalization being associated with one of the transmit antennas and being performed using a corresponding pilot code sequence;
despreading the equalized sample streams to generate despread data streams; and
performing transmit diversity decoding on the despread data streams.

9. The method of claim 8 wherein the transmit diversity is an open loop space time transmit diversity (STTD).

10. The method of claim 8 wherein the transmit diversity is a closed loop transmit diversity.

11. The method of claim 10 wherein conjugates of weights that are multiplied during transmit diversity encoding at the transmitter are multiplied to the corresponding despread data streams in performing the transmit diversity decoding.

12. The method of claim 8 wherein the equalization is normalized least mean square (NLMS) equalization.

13. The method of claim 8 wherein the equalization is channel estimation normalized least mean square (CE-NLMS) equalization.

14. The method of claim 8 wherein the receiver includes at least two receive antennas and multiple streams of samples generated from the receive antennas are merged into one combined sample stream.

15. The method of claim 8 wherein each of the interference signals includes user data transmitted by all other transmit antennas other than the associated transmit antenna.

16. The method of claim 15 wherein constructing the interference signals and subtracting the interference signals from the sample stream for each of the equalizations are performed in parallel.

17. The method of claim 13 further comprising:
measuring power of received signals corresponding to each of the transmit antennas; and
sorting the transmit antennas according to the measured power,
whereby constructing the interference signals and subtracting the interference signals from the sample stream for each of the equalizations are performed successively in an order of the measured power.

18. The method of claim 17 wherein the interference signals are constructed and subtracted either in parallel or successively in accordance with a control signal.

19. The method of claim 18 further comprising:
calculating a measured power difference between transmit antennas; and
determining whether the difference is greater than a threshold, whereby the interference signals are constructed and subtracted successively if the difference is greater than the threshold.

20. In a wireless communication system including a transmitter having a plurality of transmit antennas and a receiver, wherein the transmitter transmits different pilot code sequences via each of the transmit antennas, the receiver for supporting transmit diversity, the receiver comprising:
at least one receive antenna for receiving signals transmitted from the transmitter;
a sampling unit for generating a sample stream based on the received signals; and
a plurality of equalizers for processing the sample stream to generate a plurality of equalized sample streams, each equalizer being associated with one of the transmit antennas and processing the sample stream using a corresponding pilot code sequence while treating transmissions from all of the other transmit antennas as interference;
a plurality of despreaders for despreading the equalized sample streams to generate a plurality of despread data streams; and
a transmit diversity decoder for performing transmit diversity decoding on the despread data streams.

21. The receiver of claim 20 wherein the transmit diversity is an open loop space time transmit diversity (STTD).

22. The receiver of claim 20 the transmit diversity is a closed loop transmit diversity.

23. The receiver of claim 20 wherein the equalizers are normalized least mean square (NLMS) equalizers.

24. The receiver of claim 20 wherein the equalizers are channel estimation normalized least mean square (CE-NLMS) equalizers configured to utilize channel estimates in adapting filter tap coefficients.

25. The receiver of claim 20 wherein the receiver comprises at least two receive antennas and further comprises a data merger for merging multiple streams of sample streams generated from the receive antennas to generate one combined sample stream.

26. In a wireless communication system including a transmitter having a plurality of transmit antennas and a receiver, wherein the transmitter transmits different pilot code sequence via each of the transmit antennas, a receiver for supporting transmit diversity, the receiver comprising:
at least one receive antenna for receiving signals transmitted from the transmitter;
a sampling unit for generating a sample stream based on the received signals;
a plurality of interference construction units for constructing interference signals, each interference construction unit being associated with one of the transmit antennas and configured to construct an interference signal for canceling pilot code sequence transmitted via all of the other transmit antennas except the associated transmit antenna;
a plurality of subtractors, each subtractor being coupled to one of the interference construction units for subtracting a corresponding interference signal from the sample stream;
a plurality of equalizers, each equalizer being associated with one of the transmit antennas and processing an associated interference cancelled sample stream to generate an equalized sample stream,
a plurality of despreaders, each despreader for despreading an output of corresponding equalizer to generate a despread data stream; and
a transmit diversity decoder for performing transmit diversity decoding on the despread data streams.

27. The receiver of claim 26 wherein the transmit diversity is an open loop space time transmit diversity (STTD).

28. The receiver of claim 26 the transmit diversity is a closed loop transmit diversity.

29. The receiver of claim 26 wherein the equalizers are normalized least mean square (NLMS) equalizers.

30. The receiver of claim 26 wherein the equalizers are channel estimation normalized least mean square (CE-NLMS) equalizers configured to utilize channel estimates in adapting filter tap coefficients.

31. The receiver of claim 26 further comprising a data merger for merging multiple streams of samples generated from a plurality of receive antennas to generate one combined stream of samples.

32. The receiver of claim 26 wherein the interference signals include user data recovered by all other equalizers.

33. The receiver of claim 32 wherein constructing the interference signals and subtracting the interference signals for the equalizers are performed in parallel.

34. The receiver of claim 32 further comprising a control unit configured to sort the transmit antennas according to measured power level, whereby constructing and subtracting the interference signals for the equalizers are performed successively in an order of the measured power level.

35. The receiver of claim 34 wherein the interference signals are constructed and subtracted either in parallel or successively in accordance with a control signal.

36. The receiver of claim 35 wherein the controller generates the control signal for successive interference cancellation if a difference of power level between the transmit antennas is greater than a predetermined threshold.
